(19) United States
(12) Patent Application Publication
(10) Pub. No.: US 2026/0308972 A1
(43) Pub. Date: Oct. 8, 2026

(54) GARAGE DOOR CONTROL SYSTEMS

(71) Applicant: GM GLOBAL TECHNOLOGY OPERATIONS LLC, Detroit, MI (US)

(72) Inventors: Ahmed F. AL ALAWY, Canton, MI (US); Venkata Naga Siva Vikas Vemuri, Farmington Hills, MI (US); Mohamed A. Layouni, Macomb, MI (US); John Sergakis, Bloomfield Hills, MI (US)

(21) Appl. No.: 19/169,191

(22) Filed: Apr. 3, 2025

(51) Int. Cl. E05F 15/76; E05F 15/77

(52) U.S. Cl. CPC E05F 15/76; E05F 15/77; E05Y 2400/446; E05Y 2400/45; E05Y 2900/106

(57) ABSTRACT

An example garage door control system includes a garage door control module, and a home Internet of Things (IoT) control module configured to obtain a notification that a global positioning system (GPS) location of a vehicle is within a ranging request threshold distance of a home, and communicate with the garage door control module to enable the garage door control module to accept a ranging session request from the vehicle. The garage door control module is configured to accept the ranging session request from the vehicle to initiate a ranging session, obtain a distance of the vehicle from the home in response to communication from the home IoT control module that the vehicle is within the ranging request threshold distance of the home, and when the distance is within a door open proximity distance threshold, open the garage door in response to receiving a door open command from the vehicle.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to garage door control systems, including methods for secure access of garage doors within a connected home and vehicle environment.

Digital key access systems for vehicles include interactions between a vehicle and a mobile device, via a ranging session. Once the ranging session indicates that an appropriate range has been achieved by the vehicle to grant access to a garage door, a key exchange occurs for a seamless entry experience.

### SUMMARY

An example garage door control system includes a garage door control module configured to control opening and closing of a garage door of a home, and a home Internet of Things (IoT) control module configured to, obtain a notification that a global positioning system (GPS) location of a vehicle is within a ranging request threshold distance of the home, and in response to obtaining the notification, communicate with the garage door control module to enable the garage door control module to accept a ranging session request from the vehicle, wherein the garage door control module is configured to, accept the ranging session request from the vehicle to initiate a ranging session, in response to communication from the home IoT control module that the vehicle is within the ranging request threshold distance of the home, obtain a distance of the vehicle from the home, and when the distance is within a door open proximity distance threshold, open the garage door in response to receiving a door open command from the vehicle.

In some examples, the garage door control module is configured to execute key authentication with the vehicle prior to the garage door control module opening the garage door.

In some examples, the garage door control module is configured to execute key authentication by exchanging an authentication key with a vehicle control module of the vehicle via wireless communication.

In some examples, the home IoT control module is configured to execute key authentication with the vehicle prior to the garage door control module opening the garage door.

In some examples, the garage door control module is configured to execute key authentication with the vehicle, the home IoT control module is configured to communicate with the garage door control module to confirm authentication of the vehicle by both the garage door control module and the IoT control module, and the garage door control module is configured to open the garage door in response to approved authentication of the vehicle by both the garage door control module and the IoT control module.

In some examples, the home IoT control module is configured to, in response to the receiving the notification that the GPS location of the vehicle is within a ranging request threshold distance of a home, exchange an authentication key with a vehicle control module of the vehicle via one or more communication networks, prior to initiation of the ranging session.

In some examples, the home IoT control module is configured to, subsequent to initiation of the ranging session between the vehicle and the garage door control module, receive a notification from the garage door control module that the distance of the vehicle from the home is less than the door open proximity distance threshold, and trigger at least one of a garage door open command and a garage door unlock command.

In some examples, the home IoT control module is configured to receive the notification that the GPS location of the vehicle is within the ranging request threshold distance of the home via one or more communication networks between the vehicle and the IoT control module.

In some examples, the one or more communication networks includes at least one wireless network and at least one server. In some examples, the home IoT control module is located inside the home and is configured to control at least one electronic device other than the garage door.

In some examples, the garage door control module is configured to execute the ranging session via ultra-wideband (UWB) wireless communication between the garage door control module and a vehicle control module of the vehicle.

An example garage door control system includes a home Internet of Things (IoT) control module configured to control at least one electronic device of a home, and a garage door control module in communication with the home IoT control module, wherein the garage door control module is configured to receive a ranging session request from a vehicle to initiate a ranging session to open a garage door of a home, and transmit a notification to the home IoT control module indicative of the ranging session request from the vehicle, wherein the home IoT control module is configured to, in response to receiving the notification from the home IoT control module, request access to a global positioning system (GPS) location of the vehicle via one or more communication networks between the home IoT control module and a vehicle control module of the vehicle, determine whether the GPS location of the vehicle is within a ranging request threshold distance of the home, and in response to the GPS location of the vehicle being within the ranging request threshold distance, communicate with the garage door control module to enable the garage door control module to accept the ranging session request from the vehicle, wherein the garage door control module is configured to open the garage door in response to receiving a garage door open command from the vehicle and a distance of the vehicle from the home being within a door open proximity distance threshold.

In some examples, the garage door control module is configured to execute key authentication with the vehicle prior to the garage door control module opening the garage door.

In some examples, the garage door control module is configured to execute key authentication by exchanging an authentication key with a vehicle control module of the vehicle via wireless communication.

In some examples, the home IoT control module is configured to execute key authentication with the vehicle prior to the garage door control module opening the garage door.

In some examples, the garage door control module is configured to execute key authentication with the vehicle, the home IoT control module is configured to communicate with the garage door control module to confirm authentication of the vehicle by both the garage door control module and the IoT control module, and the garage door control module is configured to open the garage door in response to approved authentication of the vehicle by both the garage door control module and the IoT control module.

In some examples, the home IoT control module is configured to, in response to the receiving the notification that the GPS location of the vehicle is within a ranging request threshold distance of a home, exchange an authentication key with a vehicle control module of the vehicle via one or more communication networks, prior to initiation of the ranging session.

In some examples, the home IoT control module is configured to, subsequent to initiation of the ranging session between the vehicle and the garage door control module, receive a notification from the garage door control module that the distance of the vehicle from the home is less than the door open proximity distance threshold, and trigger at least one of the garage door open command and a garage door unlock command. In some examples, the one or more communication networks includes at least one wireless network and at least one server.

An example method of controlling a garage door includes obtaining, by a home Internet of Things (IoT) control module, a notification that a global positioning system (GPS) location of a vehicle is within a ranging request threshold distance of a home corresponding to the home IoT control module, in response to obtaining the notification, communicating with a garage door control module to enable the garage door control module to accept a ranging session request from the vehicle, wherein the garage door control module is configured to control opening and closing of a garage door of the home, accepting, by the garage door control module, the ranging session request from the vehicle to initiate a ranging session, in response to communication from the home IoT control module that the vehicle is within the ranging request threshold distance of the home, obtaining a distance of the vehicle from the home, and when the distance is within a door open proximity distance threshold, opening the garage door in response to receiving a door open command from the vehicle.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram of an example vehicle including a vehicle control module configured to interact with a garage door control system, according to the present disclosure;

FIG. 2 is a diagram of an example garage door control system, according to the present disclosure;

FIG. 3 is a flowchart depicting an example process for controlling access of a vehicle to opening of a garage door, according to the present disclosure;

FIG. 4 is a flowchart depicting another example process for controlling access of a vehicle to opening of a garage door, according to the present disclosure;

FIG. 5 is a flowchart depicting an example process for authenticating a vehicle in a garage door control system, according to the present disclosure; and

FIG. 6 is a flowchart depicting another example process for authenticating a vehicle in a garage door control system, according to the present disclosure.

In the drawings, reference numbers may be reused to identify similar and/or identical elements.

### DETAILED DESCRIPTION

Some example embodiments include garage door control systems which allow for secure and easy access for vehicles to home garage doors, such as by use of digital key technology and home Internet of Things (IoT) control modules. For example, ultra-wideband (UWB) wireless communication may be used for connecting vehicles with home IoT control modules for use of digital key authentication.

In some examples, access control for opening home garage doors is separated across two different devices (e.g., garage door control modules and home IoT control modules), to enhance the security and performance of garage door access by vehicles. A ranging session based on vehicle location and door open commands may be executed between a vehicle (e.g., vehicle control module) and a garage door control module, while additional security is provided via communication with a home IoT control module (e.g., a home IoT device or controller which may be configured to control other electronic devices in the home in addition to communication with the garage door control module).

In some digital key access systems for home garage doors, interactions may occur between only two devices, such as a vehicle and a mobile device. A ranging session occurs between the two devices, and once the ranging session indicates that the vehicle is within an appropriate range of the garage door to grant access, the authentication key exchange occurs for a seamless entry experience. An attack on one of the two devices (e.g., a vehicle or a garage door control module) can compromise the security of the garage door access system. Accessing the garage door may allow for access to the inside of the home, where security has a much higher priority. In order to address security concerns and issues with approaches that conduct only a ranging session between the vehicle and a garage door control module, some example embodiments incorporate a home IoT control module (e.g., a smart home IoT controller) in the decision-making process of establishing a ranging session and granting access to the garage.

In some examples, the garage door access control system is configured to allow the IoT control module to keep track of approved users and authentication keys (e.g., in a memory of the IoT control module or a database in communication with the IoT control module), determine user access rights, manage key deletion and revocation, and allow for short-term access to the garage door. The key management, access authentication, ranging request management, and other aspects of digital key management may be executed via both the garage door control module and the home IoT control module, to improve the safety of the garage door access control system. The IoT control module may also keep track of access history, to determine when each user has accessed or opened the garage door.

In various implementations, ranging and access authentication aspects of the garage door digital key access system are spread across three devices: a garage door control module, a home IoT control module, and a vehicle control module. The system may be configured to allow for a ranging session to be triggered or approved between a vehicle control module and a garage door control module, based on an agreement between the vehicle control module and a home IoT control module.

In some examples, digital key access may be granted to the vehicle control module through the home IoT control module, which may be connected on a local secure network with the garage door control module. Authentication approval of the vehicle from both the home IoT control module and the garage door control module may be needed before the vehicle is allowed to open the garage door. As mentioned above, the home IoT control module may be configured to track authorized authentication keys, users and vehicles within a local network connected with the garage door control module, and manage, add, revoke or maintain the authorized authentication keys, users and vehicles. This may facilitate a safe and seamless passive entry experience for users from their vehicle to the garage door.

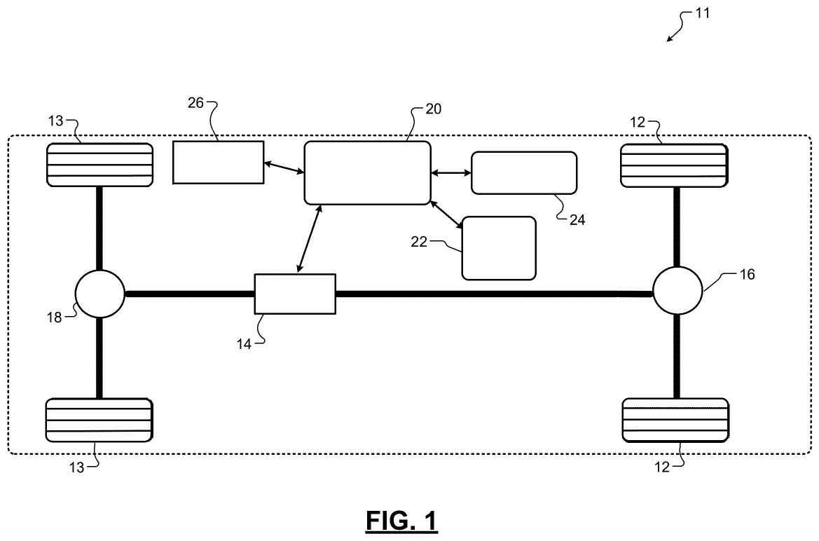

Referring now to FIG. 1, a vehicle 10 includes front wheels 12 and rear wheels 13. In FIG. 1, a drive unit 4 selectively outputs torque to the front wheels 12 and/or the rear wheels 13 via drive lines 16, 18, respectively. The vehicle 10 may include different types of drive units. For example, the vehicle may be an electric vehicle such as a battery electric vehicle (BEV), a hybrid vehicle, or a fuel cell vehicle, a vehicle including an internal combustion engine (ICE), or other type of vehicle.

Some examples of the drive unit 14 may include any suitable electric motor, a power inverter, and a motor controller configured to control power switches within the power inverter to adjust the motor speed and torque during propulsion and/or regeneration. A battery system provides power to or receives power from the electric motor of the drive unit 14 via the power inverter during propulsion or regeneration.

While the vehicle 10 includes one drive unit 14 in FIG. 1, the vehicle 10 may have other configurations. For example, two separate drive units may drive the front wheels 12 and the rear wheels 13, one or more individual drive units may drive individual wheels, etc. As can be appreciated, other vehicle configurations and/or drive units can be used.

The vehicle control module 20 may be configured to control operation of one or more vehicle components, such as the drive unit 14 (e.g., by commanding torque settings of an electric motor of the drive unit 14). The vehicle control module 20 may receive inputs for controlling components of the vehicle, such as signals received from a steering wheel, an acceleration pedal, a brake pedal, a wheel position sensor, a torque sensor connected to the steering wheel, an inertia measurement unit (IMU), a global positioning system (GPS) antenna 22, a garage door opener 24, etc. The vehicle control module 20 may monitor telematics of the vehicle for safety purposes, such as vehicle speed, vehicle location, vehicle braking and acceleration, etc.

The vehicle control module 20 may receive signals from any suitable components for monitoring one or more aspects of the vehicle, including one or more vehicle sensors (such as steering linkage torque sensors, cameras, microphones, pressure sensors, steering wheel position sensors, braking sensors, location sensors such as the global positioning system (GPS) antenna 22, wheel height and/or position sensors, accelerometers, etc.). Some sensors may be configured to monitor current motion of the vehicle, acceleration of the vehicle, braking of the vehicle, current steering direction of the vehicle, current net torque applied to a steering linkage (e.g., a torsion bar) of the vehicle, current lateral acceleration of the vehicle, current yaw rate of the vehicle, current steering wheel position and angle, current road wheel position and angle, etc.

As shown in FIG. 1, one or more GPS antennas 22 may be configured to receive GPS satellite signals to determine a current position of the vehicle 10. The current position of the vehicle 10 may be used to determine whether the vehicle 10 is within a radius distance threshold of a garage door or home (e.g., less than one mile, less than half of a mile, less than 500 yards, etc.), in order to initiate a ranging session with the garage door. A garage door opener 24 may be activated by a driver or other vehicle occupant in order to request opening of the garage door. The door open command may require the vehicle 10 to be within a proximity distance of the garage door for the door to open, which may be determined during the ranging session between the vehicle 10 and the garage door control module (such as within 500 yards, within 100 yards, within 100 feet, etc.).

In some examples, the vehicle one or more optional cameras. Each camera may include any suitable camera hardware components, image processing capabilities, etc., to capture images of surroundings of the vehicle, such as road features, other vehicles, etc. In some examples, images from vehicle cameras may be used for object detection, automated driving, lane determination, etc. Other systems such as Lidar may be used to determine images or information about the surrounding environment of the vehicle.

The vehicle control module 20 may communicate with another device via a wireless communication interface 26, which may include one or more wireless antennas for transmitting and/or receiving wireless communication signals. For example, the wireless communication interface 26 may communicate via any suitable wireless communication protocols, including but not limited to vehicle-to-everything (V2X) communication, Wi-Fi communication, wireless area network (WAN) communication, cellular communication, personal area network (PAN) communication, short-range wireless communication (e.g., Bluetooth), etc. The wireless communication interface 26 may communicate with a remote computing device over one or more wireless and/or wired networks. Regarding the vehicle-to-vehicle (V2X) communication, the vehicle 10 may include one or more V2X transceivers (e.g., V2X signal transmission and/or reception antennas).

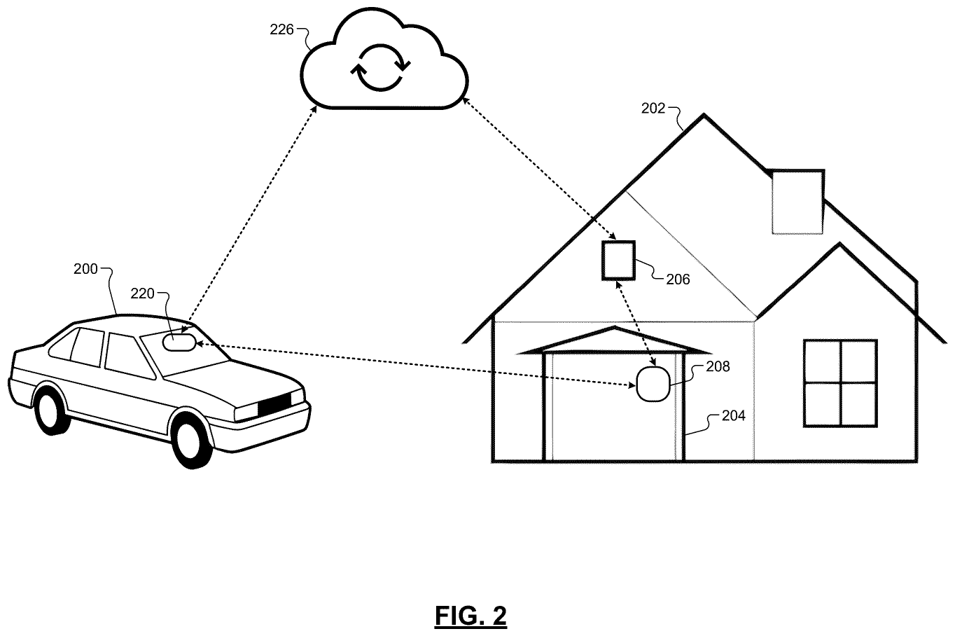

FIG. 2 is a diagram of an example garage door control system, according to the present disclosure. As shown in FIG. 2, a vehicle 200 includes a vehicle control module 220, which may communicate with one or more communication networks 226. The communication networks 226 may include any suitable cellular networks, wireless networks, Internet and cloud communication networks, one or more servers, etc.

A home 202 corresponds to the vehicle 200, and includes a garage door 204. A garage door control module 208 is electrically coupled with the garage door 204, and configured to control access to the garage door 204, opening of the garage door 204, closing of the garage door 204, etc.

The vehicle control module 220 may communicate with the garage door control module 208 to request a ranging session with the garage door control module 208, to determine a distance of the vehicle 200 from the garage door 204, to transmit a door open command to the garage door control module 208, to exchange an authentication key with the garage door control module 208, etc. In some examples, the vehicle control module 220 may communicate with the garage door control module 208 using ultra-wideband (UWB) wireless communication, BLUETOOTH or BLUETOOTH low energy (BLE) wireless communication, a Wi-Fi network, etc.

At least one home IoT control module 206 is located in the home 202. The home IoT control module 206 may include any suitable smart home device, smart home IoT controller, etc., which may be configured to control other devices in the home in addition to communicating with the garage door control module 208 (such as smart home lights, smart home electronic locks, voice-activated input devices, speakers, televisions, etc.).

The home IoT control module 206 is configured to communicate with the garage door control module 208, such as via a wired network, wireless communication, a local home network, etc. The home IoT control module 206 is also configured to communicate with the communication networks 226, which may include communication with the vehicle control module 220. For example, the home IoT control module 206 may communicate directly with the vehicle control module 220 through the communication networks 226 (which may include any suitable cellular networks, wireless networks, Internet and cloud communication networks, one or more servers, etc.), in order to obtain a location of the vehicle 200 or exchange an authentication key with the vehicle 200. In some examples, the home IoT control module 206 may access a server or other database of the communication networks 226 to request a current location of the vehicle 200, or to receive a notification of the vehicle 200 entering a specified radius distance threshold of the home 202 (such as within a one mile radius, within a half-mile, within 500 yards, within 100 yards, etc.).

In some examples, access for the vehicle 200 to the garage door 204 may be controlled using cloud to cloud communication between the vehicle 200 and home IoT control module 206. Once the vehicle is within a certain radius of the home 202, the home IoT control module 206 may be notified through the communication networks 226.

Upon receiving the notification, the home IoT control module 206 may enable the garage door control module 208 to accept ranging session requests from potential initiators, such as the vehicle 200. The vehicle control module 220 may then transmit the ranging request, which will be accepted by the garage door control module 208, to initiate the ranging session.

Once the vehicle 200 is within a proximity distance threshold of the garage door control module 208, the vehicle 200 may transmit a garage door open command to the garage door control module 208 to open the garage door 204. Key authentication between the vehicle 200 and the garage door control module 208 and/or home IoT control module 206 may be performed at any suitable point in the process, with some examples of key authentication described further below.

As another example, the vehicle 200 may first transmit a ranging session request to the garage door control module 208. Once a ranging request is received, the garage door control module 208 may alert the home IoT control module 206. The home IoT control module 206 may then request access to the vehicle's GPS location via the communication networks 226.

If the vehicle 200 is within the range where a ranging request is expected to happen, the home IoT control module 206 allows for the ranging session between the vehicle control module 220 and the garage door control module 208 to begin. Once the vehicle 200 is within an appropriate range of the garage door control module 208, the door open command can be issued from the vehicle 200 to the garage door control module 208 to open the garage door 204.

As mentioned above, the door open command authentication process may be implemented in various suitable approaches. For example, the open command authentication can be executed directly between the vehicle 200 and garage door control module 208. Once the vehicle is within the appropriate range of the garage door 204, an authentication key may be exchanged via BLE, Wi-Fi, or any other suitable wireless communication technology.

As another example, the garage door open command authentication may be performed between both the vehicle 200 and the garage door control module 208, and between the vehicle 200 and the home IoT control module 206. In this example, one or two authentication methods (or more) may be executed between the vehicle 200 and both the garage door control module 208 and the home IoT control module 206. For example, both the garage door control module 208 and the home IoT control module 206 need to approve the command for access to be granted in some implementations.

As another example, the open command authentication could be done separately over the air between the vehicle 200 and the home IoT control module 206, then locally between the home IoT control module 206 and garage door control module 208. For example, the command/key could be exchanged ahead of the ranging session, based on the home IoT control module 206 and vehicle knowledge of the vehicle's position relative to the home 202. After the ranging session occurs between the vehicle 200 and the garage door control module 208, and the vehicle 200 is within a specified proximity distance of the home 202 for granting access, the garage door control module may notify the home IoT control module 206 and home IoT control module 206 may trigger the garage open/unlock command.

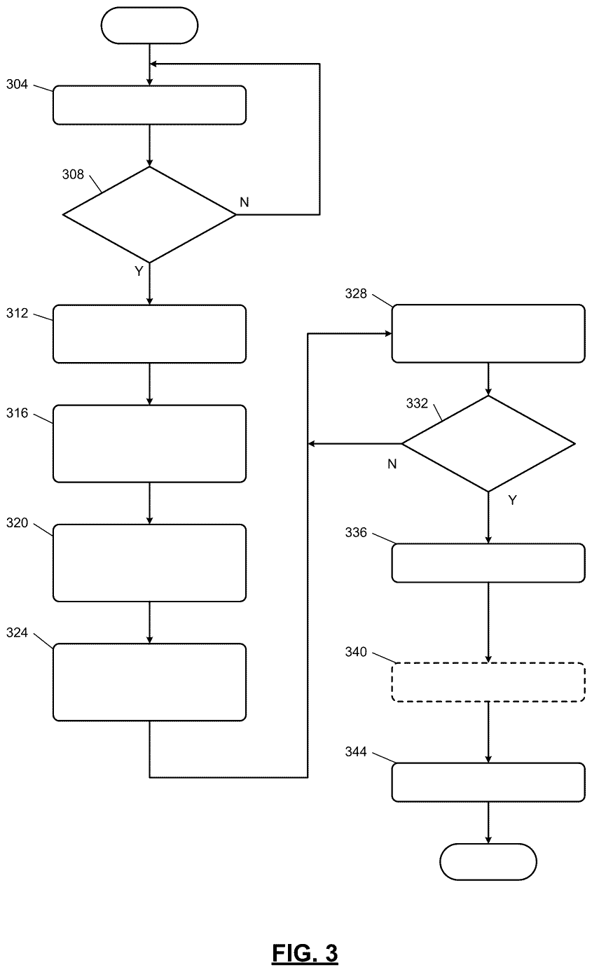

FIG. 3 is a flowchart depicting an example process for controlling access of a vehicle to opening of a garage door, according to the present disclosure. The process begins at 304, by determining a distance of the vehicle from the garage door.

At 308, control determines whether a distance of the vehicle from the garage door is less than a specified distance threshold. If not, control returns to 304 to continue determining the distance of the vehicle from the garage door. Once the vehicle is within the threshold distance at 308, control proceeds to 312 to notify the home IoT control module through one more communication networks.

At 316, the home IoT control module enables the garage door control module to accept a ranging session request from the vehicle. At 320, the vehicle transmits the ranging session request to the garage door control module. A ranging session is then initiated at 324 between the vehicle and the garage door control module, at 324.

At 328, control determines a proximity of the vehicle to the garage door control module. At 332, control checks whether the distance of the vehicle is within a proximity distance threshold. If not, control returns to 328 to continue determining how close the vehicle is to the garage door.

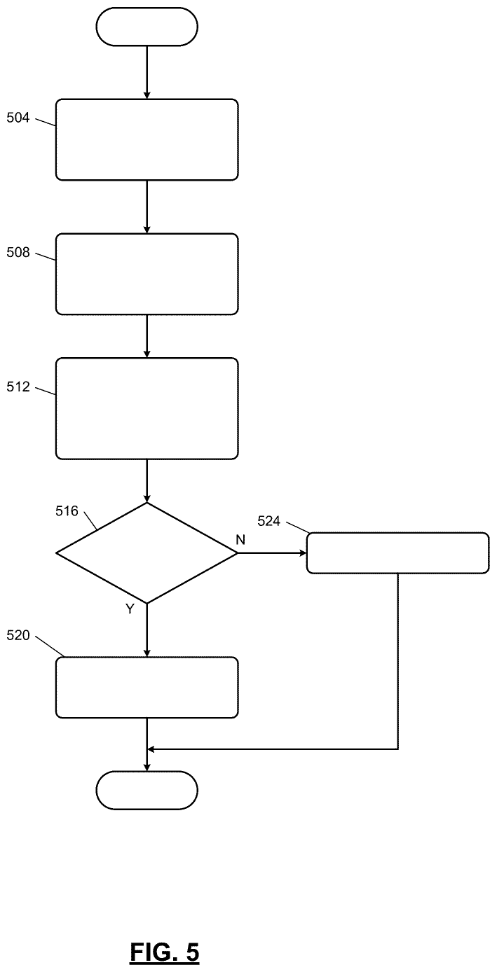

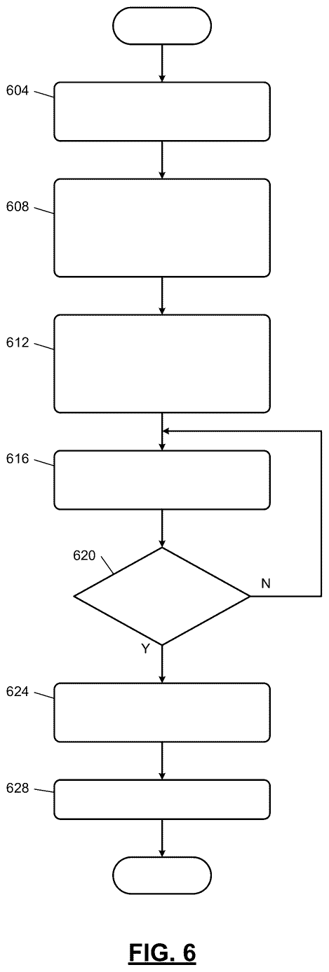

Once the vehicle is within the proximity distance threshold of the garage door at 332, control proceeds to 336 to receive a garage door open command form the vehicle. At 340, control optionally performs key authentication with the vehicle. Key authentication may be optionally performed at other points within the process of FIG. 3, or outside of the process of FIG. 3, and further example details of optional key authentication processes are described further below with reference to FIGS. 5 and 6. Once the garage door open command is received form the vehicle and approved, the garage door is opened at 344.

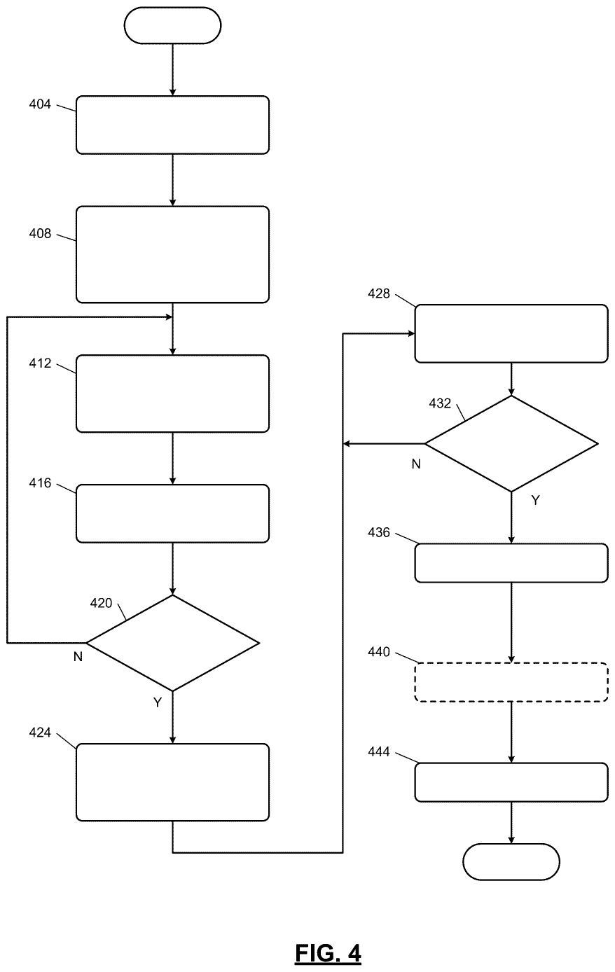

FIG. 4 is a flowchart depicting another example process for controlling access of a vehicle to opening of a garage door, according to the present disclosure. The process begins at 404, by receiving a ranging request from a vehicle at a garage door control module.

At 408, the garage door control module transmits an alert to a home IoT control module, to notify the home IoT control module of the received ranging session request. The home IoT control module then requests access to a GPS location of the vehicle via one or more communication networks, at 412.

At 416, control determines a distance of the vehicle form the garage door control module. If the distance is greater than a threshold radius distance, control returns to 412 to continue monitoring the current GPS location of the vehicle. Once the vehicle is within the threshold distance at 420, the home IoT control module allows the garage door control module to initiate the ranging session, at 424.

At 428, control determines a proximity of the vehicle to the garage door control module. At 432, control checks whether the distance of the vehicle is within a proximity distance threshold. If not, control returns to 428 to continue determining how close the vehicle is to the garage door.

Once the vehicle is within the proximity distance threshold of the garage door at 432, control proceeds to 436 to receive a garage door open command form the vehicle. At 440, control optionally performs key authentication with the vehicle. Key authentication may be optionally performed at other points within the process of FIG. 4, or outside of the process of FIG. 4, and further example details of optional key authentication processes are described further below with reference to FIGS. 5 and 6. Once the garage door open command is received form the vehicle and approved, the garage door is opened at 444.

FIG. 5 is a flowchart depicting an example process for authenticating a vehicle in a garage door control system, according to the present disclosure. The process begins at 504, by executing authentication between a vehicle control module and a garage door control module. At 508, authentication is executed between the vehicle control module and the home IoT control module, which may be separate from the vehicle to garage door control module authentication.

At 512, the garage door control module and the home IoT control module communication approval statues of their individual authentications with the vehicle. if both authentications are approved at 516 (e.g., both the home IoT control module and the garage door control module had successful authentications with the vehicle), control proceeds to 520 to open the garage door in response to a door open command from the vehicle. If one or both of the garage door control module and the home IoT control module do not approve the authentication with the vehicle at 516, an authentication error message is generated at 524 and the garage door is not opened.

FIG. 6 is a flowchart depicting another example process for authenticating a vehicle in a garage door control system, according to the present disclosure. The process begins at 604, by executing authentication between a vehicle control module and a garage door control module.

At 608, the home IoT control module confirms authentication of the vehicle with the garage door control module, via local communication with the garage door control module (e.g., a local network of the home). At 612, an authentication key is exchanged between the home IoT control module and the garage door control module, prior to initiation of a ranging session.

At 616, a distance between the vehicle and the garage door control module is determined, which may occur during a ranging session. If the vehicle is not within the proximity distance at 620, control returns to 616 to continue monitoring the distance of the vehicle.

Once the vehicle is within the proximity distance threshold at 620, control proceeds to 624 where the garage door control module notifies the home IoT control module of the vehicle proximity. The home IoT control module then triggers a garage door open command or unlock command at 628.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A garage door control system comprising:
a garage door control module configured to control opening and closing of a garage door of a home; and
a home Internet of Things (IoT) control module configured to,
obtain a notification that a global positioning system (GPS) location of a vehicle is within a ranging request threshold distance of the home, and
in response to obtaining the notification, communicate with the garage door control module to enable the garage door control module to accept a ranging session request from the vehicle,
wherein the garage door control module is configured to,
accept the ranging session request from the vehicle to initiate a ranging session, in response to communication from the home IoT control module that the vehicle is within the ranging request threshold distance of the home,
obtain a distance of the vehicle from the home, and
when the distance is within a door open proximity distance threshold, open the garage door in response to receiving a door open command from the vehicle.

2. The garage door control system of claim 1, wherein the garage door control module is configured to execute key authentication with the vehicle prior to the garage door control module opening the garage door.

3. The garage door control system of claim 2, wherein the garage door control module is configured to execute key authentication by exchanging an authentication key with a vehicle control module of the vehicle via wireless communication.

4. The garage door control system of claim 1, wherein the home IoT control module is configured to execute key authentication with the vehicle prior to the garage door control module opening the garage door.

5. The garage door control system of claim 4, wherein:
the garage door control module is configured to execute key authentication with the vehicle;
the home IoT control module is configured to communicate with the garage door control module to confirm authentication of the vehicle by both the garage door control module and the IoT control module; and
the garage door control module is configured to open the garage door in response to approved authentication of the vehicle by both the garage door control module and the IoT control module.

6. The garage door control system of claim 4, wherein the home IoT control module is configured to:
in response to the receiving the notification that the GPS location of the vehicle is within a ranging request threshold distance of a home, exchange an authentication key with a vehicle control module of the vehicle via one or more communication networks, prior to initiation of the ranging session.

7. The garage door control system of claim 6, wherein the home IoT control module is configured to:
subsequent to initiation of the ranging session between the vehicle and the garage door control module, receive a notification from the garage door control module that the distance of the vehicle from the home is less than the door open proximity distance threshold; and
trigger at least one of a garage door open command and a garage door unlock command.

8. The garage door control system of claim 1, wherein the home IoT control module is configured to receive the notification that the GPS location of the vehicle is within the ranging request threshold distance of the home via one or more communication networks between the vehicle and the IoT control module.

9. The garage door control system of claim 8, wherein the one or more communication networks includes at least one wireless network and at least one server.

10. The garage door control system of claim 1, wherein the home IoT control module is located inside the home and is configured to control at least one electronic device other than the garage door.

11. The garage door control system of claim 1, wherein the garage door control module is configured to execute the ranging session via ultra-wideband (UWB) wireless communication between the garage door control module and a vehicle control module of the vehicle.

12. A garage door control system comprising:
a home Internet of Things (IoT) control module configured to control at least one electronic device of a home; and
a garage door control module in communication with the home IoT control module, wherein the garage door control module is configured to,
receive a ranging session request from a vehicle to initiate a ranging session to open a garage door of a home, and
transmit a notification to the home IoT control module indicative of the ranging session request from the vehicle,
wherein the home IoT control module is configured to,
in response to receiving the notification from the home IoT control module, request access to a global positioning system (GPS) location of the vehicle via one or more communication networks between the home IoT control module and a vehicle control module of the vehicle,
determine whether the GPS location of the vehicle is within a ranging request threshold distance of the home, and
in response to the GPS location of the vehicle being within the ranging request threshold distance, communicate with the garage door control module to enable the garage door control module to accept the ranging session request from the vehicle, wherein the garage door control module is configured to open the garage door in response to receiving a garage door open command from the vehicle and a distance of the vehicle from the home being within a door open proximity distance threshold.

13. The garage door control system of claim 12, wherein the garage door control module is configured to execute key authentication with the vehicle prior to the garage door control module opening the garage door.

14. The garage door control system of claim 13, wherein the garage door control module is configured to execute key authentication by exchanging an authentication key with a vehicle control module of the vehicle via wireless communication.

15. The garage door control system of claim 12, wherein the home IoT control module is configured to execute key authentication with the vehicle prior to the garage door control module opening the garage door.

16. The garage door control system of claim 15, wherein:
the garage door control module is configured to execute key authentication with the vehicle;
the home IoT control module is configured to communicate with the garage door control module to confirm authentication of the vehicle by both the garage door control module and the IoT control module; and
the garage door control module is configured to open the garage door in response to approved authentication of the vehicle by both the garage door control module and the IoT control module.

17. The garage door control system of claim 15, wherein the home IoT control module is configured to:
in response to the receiving the notification that the GPS location of the vehicle is within a ranging request threshold distance of a home, exchange an authentication key with a vehicle control module of the vehicle via one or more communication networks, prior to initiation of the ranging session.

18. The garage door control system of claim 17, wherein the home IoT control module is configured to:
subsequent to initiation of the ranging session between the vehicle and the garage door control module, receive a notification from the garage door control module that the distance of the vehicle from the home is less than the door open proximity distance threshold; and
trigger at least one of the garage door open command and a garage door unlock command.

19. The garage door control system of claim 12, wherein the one or more communication networks includes at least one wireless network and at least one server.

20. A method of controlling a garage door, the method comprising:
obtaining, by a home Internet of Things (IoT) control module, a notification that a global positioning system (GPS) location of a vehicle is within a ranging request threshold distance of a home corresponding to the home IoT control module;
in response to obtaining the notification, communicating with a garage door control module to enable the garage door control module to accept a ranging session request from the vehicle, wherein the garage door control module is configured to control opening and closing of a garage door of the home;
accepting, by the garage door control module, the ranging session request from the vehicle to initiate a ranging session, in response to communication from the home IoT control module that the vehicle is within the ranging request threshold distance of the home;
obtaining a distance of the vehicle from the home; and
when the distance is within a door open proximity distance threshold, opening the garage door in response to receiving a door open command from the vehicle.
